(19) United States
(12) Patent Application Publication
(10) Pub. No.: US 2026/0180163 A1
(43) Pub. Date: Jun. 25, 2026

(54) AIRCRAFT RADOME ASSEMBLY AND RADAR

(71) Applicant: THALES, Meudon (FR)

(72) Inventors: Laurent PATAU, TOULOUSE (FR); Yoan VEYRAC, MERIGNAC (FR); Charles-Antoine L’HOUR, BREST CEDEX 3 (FR)

(21) Appl. No.: 19/430,848

(22) Filed: Dec. 23, 2025

(30) Foreign Application Priority Data
Dec. 24, 2024 (FR) FR2415224

(51) Int. Cl. H01Q 1/42; G01S 7/02; G01S 13/89; G01S 13/933; H01Q 1/28

(52) U.S. Cl. CPC H01Q 1/42; G01S 7/027; G01S 13/89; G01S 13/933; H01Q 1/281

(57) ABSTRACT

An aircraft radome and radar assembly includes: a radome arranged on the nose of the aircraft; a radar inside the radome, the radar operating in the millimeter domain and including a transmission antenna for emitting a TM polarized wave and a reception antenna; the radome includes an integrated window in front of the radar, the window being of a material transparent to millimeter waves; the radar being arranged so the angle between the maximum gain direction of the transmission antenna and the normal to the window is within an angular range [θ_{B}−θ₁; θ_{B}+θ₂], with OB being the Brewster angle for an air/window interface, θ₁ and θ₂ determined to obtain reflectivity at said air/window interface less than a predefined threshold; and an isolation partition between the transmission antenna and the reception antenna, the isolation partition being substantially in contact with the window and with the radar.

### CROSS-REFERENCE TO RELATED APPLICATIONS

This application is a U.S. non-provisional application claiming the benefit of French Application No. 24 15224, filed on Dec. 24, 2024, which is incorporated herein by reference in its entirety.

### TECHNICAL FIELD

The invention relates to an aircraft radome and radar assembly, particularly an aircraft radome and radar assembly operating in the millimeter wave domain, allowing imaging of a runway in fog.

### PRIOR ART

Today, aircraft approach and landing operations in fog are difficult to perform manually by pilots due to lack of visibility. Without visibility, landing must be imperatively performed by automatic piloting using instrument landing systems (ILS). Indeed, the current equipment placed in the aircraft and aimed at improving pilot vision during approach or landing operates in the infrared and does not allow images of the runway to be taken in fog or to reduce decision height when fog is present. Weather radars installed in the radome operate in the X-band (8-12 GHZ) and do not present sufficient resolution to be usable by the pilot for approach or landing.

Radars emitting waves in the millimeter range allow images or videos in fog to be taken. However, in order to obtain a usable image, the millimeter radar must have good RF performance without degrading aircraft characteristics. For example, it must have a negligible impact on the aerodynamics and a low impact on the aircraft weight.

Furthermore, in order to obtain an image, the quality of which is sufficient to allow the pilot to visualize the runway, the radar must point toward the runway with a sufficient directive beam to avoid dispersing emitted energy in directions unnecessary for image generation. This therefore implies constraints on the viewing angle of the radar relative to the approach slope in order to correctly aim at the runway.

The viewing angle of the radar and its associated useful cone must not intercept the metal structure of the aircraft in order to avoid disturbing signals emitted and received by the radar. Thus, this constraint implies installation at the front of the aircraft, in the aircraft radome.

However, millimeter waves do not pass through conventional radomes (often made of a quartz-epoxy honeycomb). Therefore, it is not possible to install a radar emitting waves in the millimeter domain in current commercial aircraft radomes.

Finally, some current radars present joint emission and reception antenna areas. This can induce parasitic reflections between these emission and reception antenna areas, thus distorting the obtained images.

There is therefore a need to develop a solution allowing real-time generation of images or videos of the approach scene including the runway in fog, the quality of which is sufficient to allow improved pilot vision during approach or landing, while respecting current commercial aircraft constraints in terms of material resistance standards, aerodynamics, and weight.

### SUMMARY OF THE INVENTION

To overcome the aforementioned drawbacks, the invention proposes an aircraft radome and radar assembly comprising:
a radome arranged on the nose of the aircraft;
a radar, arranged inside the radome, the radar being configured to operate in the millimeter domain and comprising a transmission antenna configured to emit a TM polarized wave and a reception antenna;
   the radome comprising a window integrated into said radome, the window being of a material transparent to millimeter waves, the window being in front of the radar;
   the radar being arranged in such a way that the angle between the maximum gain direction (MGD) of the transmission antenna and the normal to the window is within an angular range [θ_{B}−θ₁; θ_{B}+θ₂], with OB being the Brewster angle for an air/window interface, θ₁ and θ₂ determined to obtain reflectivity at said air/window interface less than a predefined threshold; and
an isolation partition arranged between the transmission antenna and the reception antenna, the isolation partition being substantially in contact with the window and with the radar.

In one embodiment, the radar is a frequency-modulated continuous wave radar.

In one embodiment, the radar emits in a frequency band between 95 GHz and 100 GHz.

In one embodiment, the window has a dimension such that an emitted wave included in an emission angular field and a received wave included in the radar reception angular field pass through the window.

In one embodiment, the window material comprises cross-linked polystyrene plastic, or a polyetherimide resin, or polytetrafluoroethylene.

In one embodiment, the window presents a radius of curvature greater than 1.2 m.

In one embodiment, the window material presents a permittivity such that a value of the associated Brewster angle is between 50° and 65°.

In one embodiment, a window material presents a permittivity such that a value of the associated Brewster angle is compatible with positioning the radar inside the radome and/or with the radome slope.

In one embodiment, the isolation partition presents a metallic core covered with an absorbing material.

In one embodiment, the window is integrated into the radome with a joining material.

The following description presents several embodiments of the aircraft radome and radar assembly of the invention: these examples are not limiting of the scope of the invention. These embodiments present both the essential characteristics of the invention as well as additional characteristics related to the considered embodiments.

### BRIEF DESCRIPTION OF THE DRAWINGS

The invention will be better understood, and other advantages will appear upon reading the following description given as a non-limiting example and by means of the figures among which:

FIG. 1 illustrates an aircraft radome and radar assembly according to the invention viewed from the side;

FIG. 2A represents a top view of the aircraft, illustrating the horizontal pattern at the reception antenna level;

FIG. 2A represents a side view, illustrating the vertical pattern at the reception antenna level and the vertical pattern at the transmission antenna level;

FIG. 3 illustrates the reflectivity according to the angle of incidence when the window is of cross-linked polystyrene of the Rexolite™ type;

FIG. 4 illustrates a simplified model of the optical paths of rays coming from the elementary antennas and propagating through the window, according to an example, the view being a cross-section in azimuth; and

FIG. 5 illustrates the optical path difference of a wave emitted by the transmission antenna.

### DETAILED DESCRIPTION

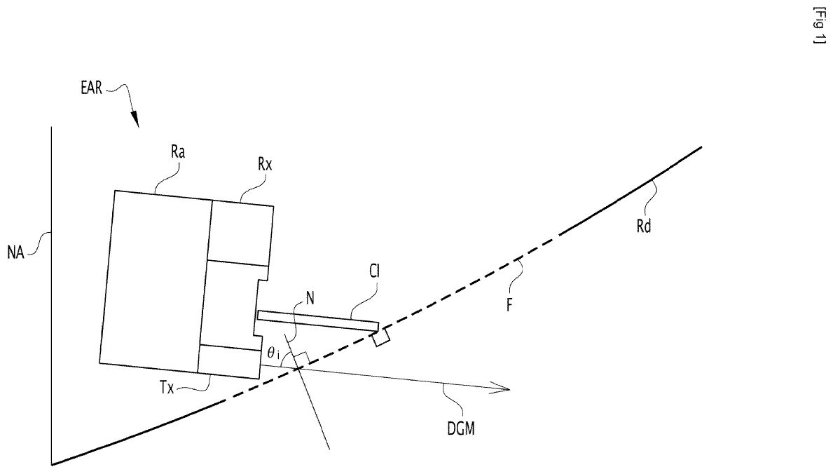

The invention relates to an assembly comprising an aircraft radome and a radar. FIG. 1 illustrates an aircraft radome and radar assembly EAR according to the invention.

The aircraft radome and radar assembly EAR comprises a radome Rd arranged on the nose of the aircraft NA. The aircraft is, for example, a plane or a drone.

Moreover, the aircraft radome and radar assembly EAR comprises a radar Ra. The radar Ra is arranged inside the radome Rd. The radar Ra is configured to operate in the millimeter domain. Advantageously, the millimeter domain allows images or videos to be taken in fog while using small-sized radars, unlike weather radars commonly used to take weather images, or in clouds or rain. Indeed, these weather radars require, for a same resolution, radar sizes about ten times larger to take images in fog than the millimeter radars and therefore could not be embarked on an aircraft. The radar Ra comprises a transmission antenna Tx configured to emit a TM polarized wave and a reception antenna Rx. Thus, the transmission antenna Tx emits a millimeter wave that propagates toward the runway, which is in the radar field when the aircraft, a plane for example, is about to land. The wave is then backscattered by the runway, even in difficult weather conditions, such as fog. The reflected wave is then captured by the reception antenna Rx, then transformed into an image or video by the radar Ra. In addition, millimeter radars can be compact, which is particularly advantageous on board aircraft where space and weight constraints are high.

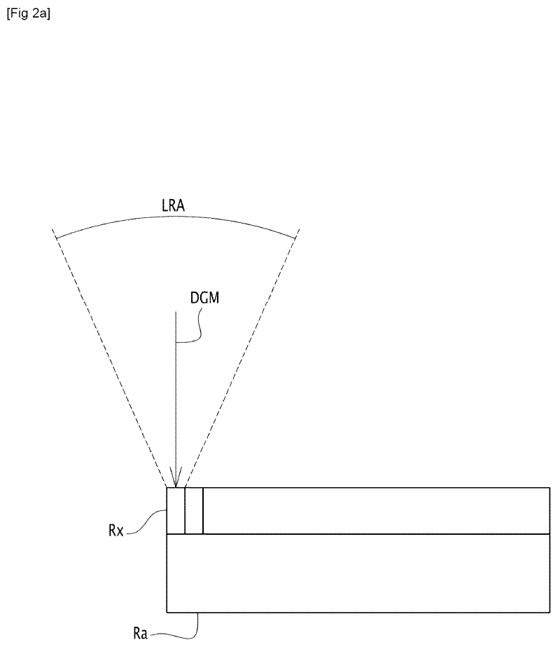

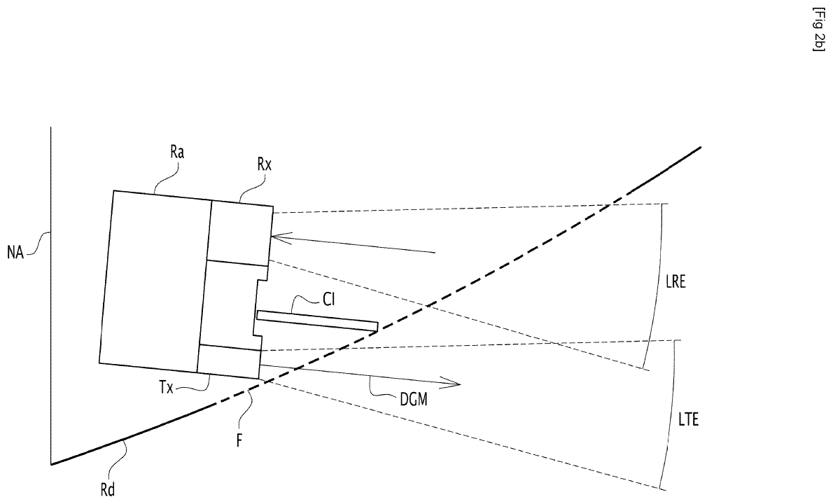

The waves emitted by the transmission antenna Tx and received by the reception antenna Rx form lobes. FIGS. 2A and 2B represent a top view and a side view of the aircraft, allowing to illustrate on FIG. 2B of the vertical pattern at the reception antenna level LRE and the vertical pattern at the transmission antenna level LTE, and on FIG. 2A the horizontal pattern at the reception antenna level LRA.

Furthermore, the radome Rd comprises a window F integrated into the radome Rd. The window F is of a material transparent to millimeter waves. The window F is in front of the radar Ra. The radomes, for example of commercial aircraft, are typically of a quartz-epoxy honeycomb. The millimeter waves of the radar Ra do not pass through these materials. It is therefore necessary for the radome to comprise a part transparent to millimeter waves in order to be able to transmit the waves and receive them back. Advantageously, the window F thus allows the use of a radar in the millimeter domain located inside the radome.

As illustrated in FIG. 2B, the radar Ra and the window F are configured so that the transmission and emission lobes pass through the window F, thus allowing the radar to image the runway.

Furthermore, the radar Ra is arranged so that the angle θi between the maximum gain direction MGD of the transmission antenna Tx and the normal N to the window F is within an angular range [θ_{B}−θ₁°; θ_{B}+θ₂], with OB being the Brewster angle defined for the air/window interface, and θ₁, θ₂ determined to obtain reflectivity at said air/window interface less than a predefined threshold. The predefined threshold is, for example, between −25 dB and −10 dB, preferably equal to −15 dB or −20 dB. As indicated above, the transmission antenna Tx is configured to emit a TM polarized wave. The TE polarization presents a strictly increasing reflection coefficient with incidence. The TM polarization presents a minimum reflection for Brewster incidence, which corresponds to total wave transmission through the window F. In the present invention, the reflection coefficient must be minimized since it corresponds to losses at emission (the wave reflected toward the inside of the radome) and reception (environment echoes reflected at the radome surface). Furthermore, the energy reflected at emission tends to mismatch the antennas and degrade emission performance (power, pointing accuracy). Advantageously, when the radar Ra is arranged in such a way that the angle θi between the maximum gain direction of the transmission antenna Tx and the normal N to the window F is equal to the Brewster angle θ_{B}, it is possible to minimize the energy reflected at the air/window interface at emission. A certain tolerance around this angle θ_{B} is acceptable, of −θ₁/+θ₂.

Furthermore, the aircraft radome and radar assembly EAR comprises an isolation partition CI arranged between the transmission antenna Tx and the reception antenna Rx. The isolation partition CI is configured to prevent reflections of rays emitted by the transmission antenna Tx on the window from being detected by the reception antenna Rx. The partition CI therefore forms a lateral obstacle for the emitted wave. The partition CI is substantially in contact with the window F and with the radar Ra to prevent the aforementioned reflections. By substantially in contact, it is meant contact with close mechanical play. In one embodiment, the mechanical play is ensured by a deformable absorber (such as foam) between the partition and the aircraft radome, and/or between the partition and the radar. The isolation partition CI thus creates an isolation boundary between the transmission Tx and reception Rx antennas. This boundary between the Rx, Tx antennas thus allows to preserve the transmission lobe of the transmission antenna Tx. Advantageously, the isolation partition CI, allows, by reducing reflections between the transmission antenna Tx and the reception antenna Rx, to limit parasitic waves and thus improves the quality of the runway images or videos obtained by the radar Ra.

Thus, advantageously, the invention allows to assist pilots in landing in difficult weather conditions such as fog. The invention allows images of sufficient quality to improve pilot vision during approach or landing to be taken, while respecting current commercial aircraft constraints in terms of materials, aerodynamics, and weight. Thus, the pilot can, for example, perform approach and landing protocols, even in fog, such as “EFVS approach” or “EFVS landing” protocols (EFVS meaning enhanced flight vision system).

In one embodiment, the isolation partition CI is fixed on the radar Ra, and a baffle is arranged in the window F, in which the isolation partition CI is arranged, thus allowing mechanical play between the isolation partition CI and the window F. In one alternative embodiment, a baffle is arranged in the window F in which the isolation partition CI is arranged, and another baffle is arranged on the radar, between the two transmission and reception antennas Tx, Rx, in which the isolation partition CI is also arranged. Advantageously, the baffle thus allows to resist the mechanical constraints to which the radar Ra is subjected to, in a difficult flight environment.

In one embodiment, the radar Ra is a frequency-modulated continuous wave radar. Advantageously, the frequency-modulated continuous wave radar allows to image the runway continuously during approach or landing.

In one embodiment, the radar Ra emits in a frequency band between 95 GHz and 100 GHz. Advantageously, this frequency band allows images to be taken through fog, and thus to take images of the runway, allowing to assist pilots in landing.

In one embodiment, the window F has a dimension such that an emitted wave included in an emission angular field and a received wave included in the radar reception angular field pass through the window. Advantageously, the dimension of the window allows the radar field of view to be maximized, so that emitted waves are not blocked by the radome.

In one embodiment, a window F material presents a permittivity such that a value of the associated Brewster angle (air/window interface) is compatible with positioning the radar inside the radome and/or with the radome slope. In particular, the radar Ra must be positioned behind the window F, to aim at the runway. The positioning angle of the radar Ra is therefore limited by the shape of the radome Rd, often defined by the aircraft manufacturer as well as by the angle allowing to aim at the runway. Thus, it can be difficult to obtain the Brewster angle at incidence on the window for the ray emitted from the transmission antenna Tx (MGD direction) in view of these constraints. It is possible to adjust the Brewster angle value by adjusting the permittivity of the material of the window F. It is therefore possible to choose a material of the window F the permittivity of which allows the desired Brewster angle value to be obtained.

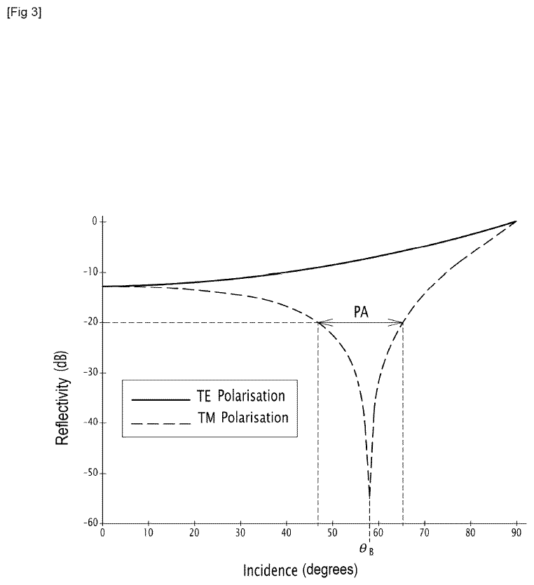

Thus, in one embodiment, the window material comprises cross-linked polystyrene plastic, for example of the Rexolite™ type, or a polyetherimide resin, for example of the Ultem™ type, or polytetrafluoroethylene. These materials present a permittivity such that a value of the associated Brewster angle is between 50° and 65°. In particular, the Ultem™ permittivity allows a Brewster angle of 63° to be obtained, polytetrafluoroethylene allows a Brewster angle of 54° to be obtained, and Rexolite™ allows a Brewster angle of 58° to be obtained. FIG. 3 represents the reflectivity according to the angle of incidence for both TE and TM polarizations when the window is of cross-linked polystyrene type Rexolite™. It is well illustrated that Rexolite™ allows a Brewster angle of 58° to be obtained. A range of incidence angle values around the Brewster angle is however acceptable for minimizing losses and parasitic reflections, as described above, for example a range [38°; 73°]. Preferably, an attenuation of the reflected wave of at least-15 dB, or even-20 dB, is sought. As illustrated in FIG. 3, for Rexolite™ and an attenuation of −20 dB, this range PA of incidence angle values θi is preferably between 46° and 65°.

Rexolite™ is particularly advantageous because it allows the thickness of the window, typically around 6 to 7 mm, to be reduced, to attenuate the signal in an acceptable manner while maintaining the required rigidity in the difficult environmental conditions of aircraft.

In one embodiment, the window F presents a radius of curvature greater than 1.2 m.

In order to best approach the radar to the radome, it is necessary for the window to present an acceptable radius of curvature. Indeed, a flat shape would make it complex to connect with the rest of the radome in azimuth.

A simulation was carried out to evaluate the acceptable radius of curvature of the window F. A window of Rexolite™ was used for the simulation. In order to limit the dimensions of the window, it is considered that the antenna lobe widths are limited by the angle values corresponding to a 3 dB attenuation relative to the maximum emission direction. This applies for both the transmission Tx as well as the reception Rx antennas, both in azimuth and elevation. The angular width of the cone LTE is +10° upward and −14° downward around the MGD direction. The angular width of the azimuth emission cone LTA is 15° to the left and right.

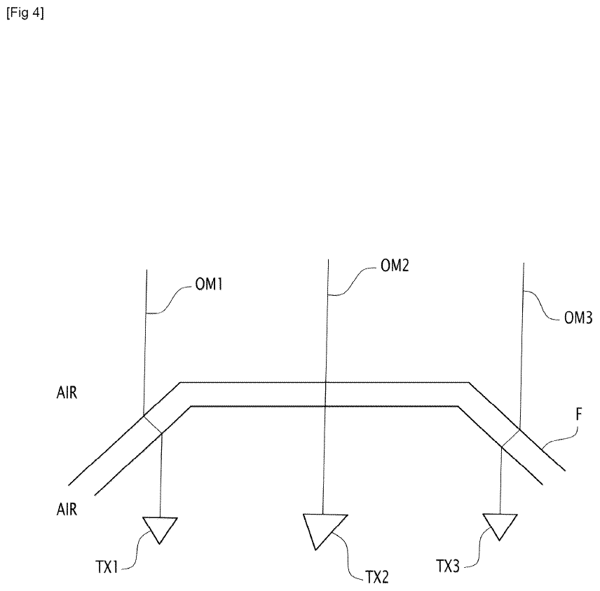

In azimuth, a curvature of the window is modeled in three sections, and three rays OM1, OM2, OM3 emitted respectively by the elementary transmission antennas Tx1, Tx2, Tx3, each passing through a section of the window, as illustrated in FIG. 4.

The window sections thus modeled have parallel inner and outer surfaces. Consequently (since the dielectric is considered homogeneous), the entry and exit directions of the millimeter waves are parallel. However, the geometry and refraction laws (obeying Snell-Descartes laws) applied locally induce non-linear propagation from the emitter horns to free space propagation, as illustrated in FIG. 4. Thus, there is an optical path difference brought by the window, relative to free space propagation.

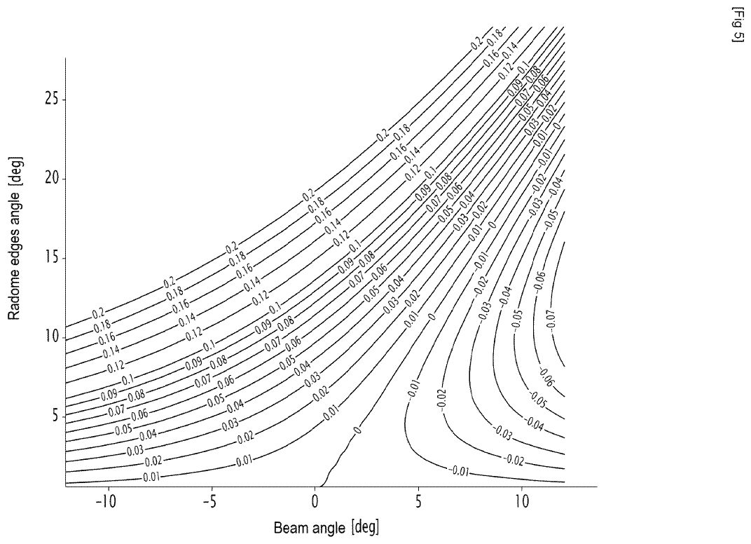

FIG. 5 illustrates the optical path difference (expressed in multiples of A, the radar emission wavelength). It is the optical path difference between the central horn and an end-of-array horn, in excess of the theoretical optical path difference associated with each viewing angle, and expressed in multiples of λ. FIG. 5 illustrates the iso-value curves of optical path difference in fractions of λ. This additional optical path difference is due to the shape of the window F and is a function of the millimeter wave emission angle through the window F and the angle defining the inclination of the lateral segments of the window F. The acceptable zone according to the emission angle and the inclination of the lateral segments is the one for which there is an additional optical path difference less than a fixed fraction of the wavelength. It is estimated that the formed image will remain exploitable for an optical path differential of 0.1λ at most. With this 0.1λ value, it is possible to determine a retained angle with the radome edges which, in combination with the total antenna width, the dimension of each section, the angle between the sections, and manufacturer constraints, allows the minimum admissible radius of curvature for the window F to be determined. As an indication, a value of the minimum admissible radius of curvature for the window F is 1.2 m.

In one embodiment, the isolation partition presents a metallic core covered with an absorbing material. Advantageously, this allows the isolation partition CI to prevent reflections of rays emitted by the transmission antenna Tx on the radome Rd from being detected by the reception antenna Rx. Thus, by avoiding these reflections, it improves the quality of the images or videos obtained with the radar and therefore allows the pilot to visualize the runway more precisely. In one embodiment, the absorbing material is a dielectrically charged elastomer, such as for example, a silicone resin. These materials allow waves in the millimeter domain to be absorbed.

In one embodiment, the window F is integrated into the radome Rd with a joining material. Advantageously, the joining material allows to limit the mechanical constraints caused by the different materials used for the window and the rest of the radome. In one embodiment, the joining material is a fiberglass composite.

Although the invention has been illustrated and described in detail using one preferred embodiment, the invention is not limited to the disclosed examples. Other alternatives can be deduced by a person skilled in the art without departing from the scope of protection of the claimed invention.

1. An aircraft radome and radar assembly comprising:
a radome arranged on the nose of the aircraft;
a radar, arranged inside the radome, the radar being configured to operate in the millimeter domain and comprising a transmission antenna configured to emit a TM polarized wave and a reception antenna;
the radome comprising a window integrated into said radome, the window being in a material transparent to millimeter waves, the window being in front of the radar;
the radar being arranged in such a manner that the angle between the maximum gain direction of the transmission antenna and the normal to the window is within an angular range [θ_{B}−θ₁; θ_{B}+θ₂], with OB being the Brewster angle for an air/window interface, θ₁ and θ₂ determined to obtain reflectivity at said air/window interface less than a predefined threshold; and
an isolation partition arranged between the transmission antenna and the reception antenna, the isolation partition being substantially in contact with the window and with the radar.

2. The aircraft radome and radar assembly according to claim 1, wherein the radar is a frequency-modulated continuous wave radar.

3. The aircraft radome and radar assembly according to claim 1, wherein the radar emits in a frequency band between 95 GHz and 100 GHz.

4. The aircraft radome and radar assembly according to claim 1, wherein the window has a dimension such that an emitted wave included in an emission angular field and a received wave included in the radar reception angular field pass through the window.

5. The aircraft radome and radar assembly according to claim 1, wherein the window material comprises cross-linked polystyrene plastic.

6. The aircraft radome and radar assembly according to claim 1, wherein the window material comprises a polyetherimide resin.

7. The aircraft radome and radar assembly according to claim 1, wherein the window material comprises polytetrafluoroethylene.

8. The aircraft radome and radar assembly according to claim 1, wherein the window presents a radius of curvature greater than 1.2 m.

9. The aircraft radome and radar assembly according to claim 1, wherein the window material presents a permittivity such that a value of the associated Brewster angle is between 50° and 65°.

10. The aircraft radome and radar assembly according to claim 1, wherein a window material presents a permittivity such that a value of the associated Brewster angle is compatible with positioning the radar inside the radome and/or with the radome inclination.

11. The aircraft radome and radar assembly according to claim 1, wherein the isolation partition presents a metallic core covered with an absorbing material.

12. The aircraft radome and radar assembly according to claim 1, wherein the window is integrated into the radome with a joining material.
